(19) United States
(12) Patent Application Publication
(10) Pub. No.: US 2012/0007731 A1
(43) Pub. Date: Jan. 12, 2012

(54) I C U helmet stop lamp

(76) Inventor: Alfred Martinez, Pico Rivera, CA (US)

(21) Appl. No.: 13/135,441

(22) Filed: Jul. 5, 2011

Related U.S. Application Data
(60) Provisional application No. 61/398,960, filed on Jul. 2, 2010.

(51) Int. Cl. B60Q 1/44

(52) U.S. Cl. 340/479

(57) ABSTRACT

The Helmet Stop Lamp is incorporated into motorcycle helmets. At the lower rear of the helmet, a horizontal array of five red LED, light-emitting diodes, are incorporated into the helmet. These diodes are powered by current from a secure plug-in jack which is incorporated into the right rear of the helmet. The jack, in turn, extends through a flexible, spiral, extensible coated wire approximately three feet in length, this wire fitted with another plug-in jack at the distal end, and this jack in turn plugs into a fitting which is wired into the bike's electrical system. Once the jacks are plugged in, the act of braking, handbrake or footbrake or both, closes a switch and creates a circuit in which current flows to the LED array at the rear of the helmet. The stronger the braking, the more current moves to the LED's, and the brighter and more intense the red lights glow.

### CLAIM OF PRIORITY

This patent application claims priority under 35 USC 119 (e) (1) from U.S. Provisional Patent Application Ser. No. 61/398,960 filed Jul. 2, 2010, of common inventorship herewith entitled, “ICU Helmet Stop Lamp.”

### FIELD OF THE INVENTION

The present invention pertains to the field of motorcycle safety devices, and more specifically to the field of motorcycle helmet integrated brake light devices.

### BACKGROUND OF THE INVENTION

The prior art has put forth several designs for motorcycle helmet integrated brake light devices. Among these are:

U.S. Pat. No. 4,760,373 to Richard M. Reily describes a safety helmet to be worn by motorcyclists which contains a backward facing warning light which shines when the motorcycle's brake pedal is depressed. To avoid using a wired connection between the motorcycle and the helmet a transmitter is attached to the motorcycle and a receiver which activates the light is installed inside the helmet.

U.S. Pat. No. 5,910,764 to Dwayne E. Hayden describes a helmet brake light system which includes a helmet, a helmet brake light coupled to the rear of the helmet, a light intensity detector coupled in close proximity to the motorcycle's brake light and an electrical cable electrically coupled to a batter source in the helmet and the light intensity detector.

U.S. Pat. No. 6,784,795 to Muriel Pories, et al describes a brake and signal light system for use with a vehicle, such as a motorcycle and a helmet worn by a rider of the motorcycle. The system includes a transmitter mounted to the vehicle and electrically connected to the signaling circuitry of the vehicle for broadcasting a coded radio signal in response to a current passing through the signaling circuitry of the vehicle.

None of these prior art references describe the present invention.

### SUMMARY OF THE INVENTION

It is an object of the present invention to provide a motorcycle helmet integrated brake light device.

### BRIEF DESCRIPTION OF THE DRAWINGS

FIG. 1 is an elevational angled perspective view of the device of the present invention.

FIG. 2 is a close-up right angled perspective view of a portion of the device of the present invention.

FIG. 3 is a close-up rear angled perspective view of a portion of the device of the present invention.

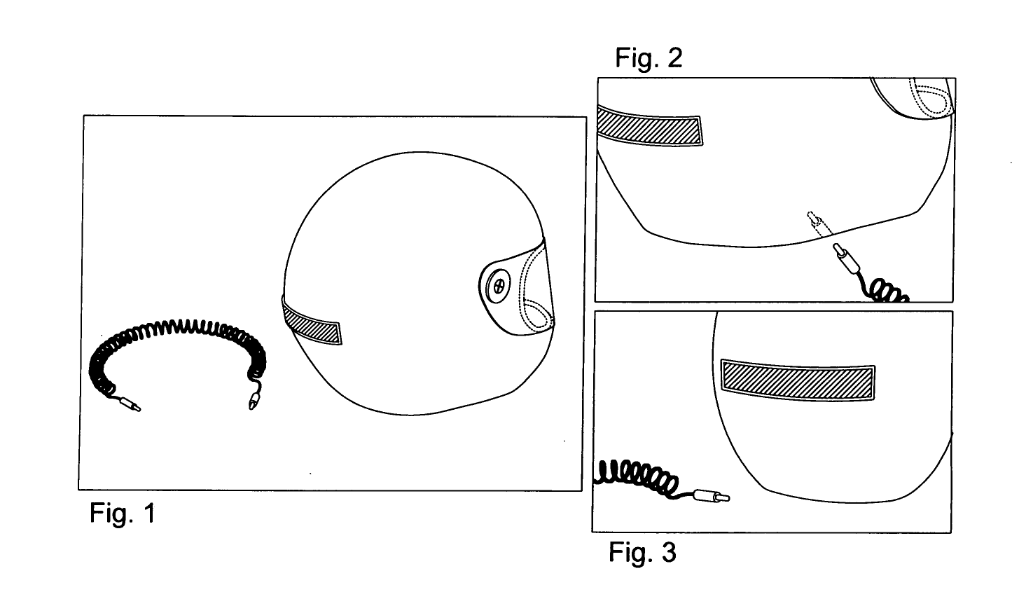

### DETAILED DESCRIPTION OF THE INVENTION

The present invention, hereinafter referred as the I.C.U. (I See You) Helmet Stop Lamp, equips premium-quality motorcycle helmets with a brake-activated stoplight, equivalent to those mounted inside the rear glass of automobiles that prevents accidents and saves bikers' lives.

The Helmet Stop Lamp is incorporated into motorcycle and All-Terrain Vehicle helmets manufactured by the Motorcycles, Bicycles, and Parts industry, Standard Industrial Code 3751. At the lower rear of the Helmet, a horizontal array of five red LED, light-emitting diodes, are incorporated into the helmet. These diodes are powered by current from a secure plug-in jack which is incorporated into the right rear of the helmet. The jack, in turn, extends through a flexible, spiral, extensible coated wire approximately three feet in length, this wire fitted with another plug-in jack at the distal end, and this jack in turn plugs into a fitting which is wired into the bike's electrical system. No auxiliary power system, such as batteries, is required. Once the jacks are plugged in, one to the bike and one to the helmet, the act of braking, handbrake or footbrake or both, closes a switch and creates a circuit in which current flows to the LED array at the rear of the helmet. The stronger the braking, the more current moves to the LED's, and the brighter and more intense the red lights glow. No On/Off switches are required to activate the Helmet Stop Lamp system, the user merely connects the jacks and wire between helmet and bike. From there, the Helmet Stop Lamp system operates automatically.

For motorcyclists and ATV riders, and for the larger motoring public, the Helmet Stop Lamp provides enhanced safety. Just as new passenger vehicles are now required to have an interior, rear braking lamp for greater visibility, so the Helmet Stop Lamp augments a motorcycle's brake lights by placing an auxiliary brake lamp in the rear of the cyclist's helmet. Just as the interior brake lamps in passenger vehicles provide a good visual indicator of how hard a vehicle is braking, so does the Helmet Stop Lamp provide increasingly intense red illumination as the braking operation becomes more intense. The end-result is that, when following a motorcycle, a driver has a more visible, clearer, earlier indication when the rider is braking, and a clearer signal on how hard the rider is braking. In low-visibility driving conditions, the Helmet Stop Lamp clearly spells the difference between a car striking a bike, or stopping or slowing in time. Without doubt, the Helmet Stop Lamp enhances the safety of motorcyclists and ATV riders, and because the system is incorporated into the manufacture of top-quality helmets at very little increase in cost, this lifesaving invention finds a wide and enthusiastic market among the nation's bikers and ATV riders.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A motorcycle helmet brake light device, comprising an array of LED, light-emitting diodes, incorporated into the lower rear of a helmet, wherein these diodes are powered by current from a secure proximal plug-in jack which is incorporated into the right rear of the helmet and wherein the proximal plug-in jack extends through a flexible, spiral, extensible coated wire and wherein the wire is fitted with a distal end plug-in jack, and this distal end plug-in jack plugs into a fitting which is wired into the bike's electrical system.

2. The device of claim 1 wherein the LED's number five and are red in color.

3. The device of claim 1 wherein the array of LED's is essentially horizontal.

4. The device of claim 1 wherein the extensible coated wire is approximately three feet in length.

5. The device of claim 1 wherein the act of braking, handbrake or footbrake or both, closes a switch and creates a circuit in which current flows to the LED array at the rear of the helmet.

6. The device of claim 5 wherein the act of braking, handbrake or footbrake or both, closes a switch and creates a circuit in which current flows to the LED array at the rear of the helmet and the stronger the braking, the more current moves to the LED's, and the brighter and more intense the lights glow.
